(19) United States
(12) Patent Application Publication
(10) Pub. No.: US 2015/0077860 A1
(43) Pub. Date: Mar. 19, 2015

(54) Beam Profile in Particle Counter

(71) Applicants: Rocco D. Pochy, Milpitas, CA (US); David N. Wells, Silver Spring, MD (US)

(72) Inventors: Rocco D. Pochy, Milpitas, CA (US); David N. Wells, Silver Spring, MD (US)

(21) Appl. No.: 14/486,902

(22) Filed: Sep. 15, 2014

Related U.S. Application Data
(60) Provisional application No. 61/877,900, filed on Sep. 13, 2013.

(51) Int. Cl. G02B 27/09

(52) U.S. Cl. CPC G02B 27/0927; G02B 27/0955
USPC 359/708

(57) ABSTRACT

A particle counter system is disclosed having a linear diverging lens, preferably a Powell lens, in order to create a top-hat profile without a loss of beam energy. The particle counter system disclosed creates ideal beam intensity distribution across the ribbon of light originating from the laser diode of the particle counter.

### CONTINUITY

This application is a non-provisional application of provisional application No. 61/877,900, filed on Sep. 13, 2013, and priority is claimed thereto.

### FIELD OF THE PRESENT INVENTION

The present invention relates to particle detection and counting via the use of a conventional particle counter, and more specifically to the beam profile employed by a particle counter in order to accurately detect and provide information pertaining to airborne particles in the air.

### BACKGROUND OF THE PRESENT INVENTION

As it is known to those skilled in the art, a common approach in conventional particle counter design is a beam clipping design, which is employed to shape the particle counting beam. A cylindrical lens is conventionally used to shape the beam to create a “ribbon” of light that the particles would pass through. Using apertures, the beam is clipped so the shape resembles that of a “top hat” profile. This is so the particles of the same size would have equal reflected energy as it passes through any part of the beam. The truncated Gaussian beam gives a better response than a full Gaussian beam, but there are variations to the signal depending on path which the particle travels through the beam (stronger signal through the center, weaker signal toward the edges).

The Powell lens (U.S. Pat. No. 4,826,299) is able to take a Gaussian beam and create a “top hat” profile without loss of beam energy (no clipping) and creates a very good beam intensity distribution across the ribbon of light.

The benefits to the implementation and use of the Powell lens on a particle counter beam include:
1. Improves signal peak resolution of mono-dispersed particles. This improves the ability to resolve different size particles.
2. Minimal loss of laser energy to allow a stronger signal.

### However, the Challenges:

1. Performance critical to input beam size.
2. Higher cost than clipping method.
   For comparison:

| Technology | Benefits | Issues |
|---|---|---|
| Beam Clipping | Easy & Inexpensive | Efficiency vs Uniformity trade |
| | | off |
| | | Power loss |
| Diffractive | Not dependent on input | High setup cost |
| | beam size | Not Efficient |
| | Flexible design format | Wavelength dependent |
| | | High ripple noise |
| Powell | Excellent Efficient | Input beam size dependent |
| | Good Uniformity | |
| | Wavelength independent | |
| | Low ripple noise | |

“The use of a “sheet of light” is common in the industry (U.S. Pat. No. 8,253,939B2) but the creation of an efficient intensity profile is not. Thus there is a need for an method of use for a particle counter that is able to establish a stable and ideal top-hat beam pattern while remaining uniform and financially efficient via the use of a Powell lens.

### SUMMARY OF THE PRESENT INVENTION

It is known that the beam originating from the laser diode in a particle counter tends to have a diverting beam with an elliptical cross section. This diverting beam is not ideal when capturing light as particles pass through the beam. Ideally, for optimal use of the particle counter, there would be a flat sheet of light and the particle would only be illuminated as it passes through it.

The initial reason for the beam of light in a particle counter is to provide a screen that the particles can be seen as penetrating. The amount of light scattered is proportional to the size of the particle.

As previously mentioned, the Powell lens is able to take a Gaussian beam and create a “top hat” profile without loss of beam energy (no clipping) and creates a very good beam intensity distribution across the ribbon of light. The present invention aims to implement a Powell lens, or a lens similar to that of a Powell lens, in order to achieve the “top hat” ideal beam profile from the laser diode or other light source of the particle counter.

### BRIEF DESCRIPTION OF THE DRAWINGS

FIG. 1 depicts the top hat pattern of the particle beam when the method of the present invention is implemented.

### DETAILED DESCRIPTION OF THE PREFERRED EMBODIMENT

A system for improving the beam profile of a particle counter is disclosed, which includes a Powell lens and a conventional particle counter. If the beam or “ribbon” of light emitted from the laser diode and focused through a lens is not uniform, then particles on the edge of the beam would look distorted (incorrectly sized) compared to the particles near the center of the beam profile. In order to combat this issue, the present invention employs the Powell lens. Rather than clipping parts of the beam to force a top-hat profile as prior methods required, the Powell lens re-focuses the light thus using all the energy coming from the laser. The re-focusing of the light produces the ideal top-hat profile, ensuring that particle sizes are uniform and consistent across the sample.

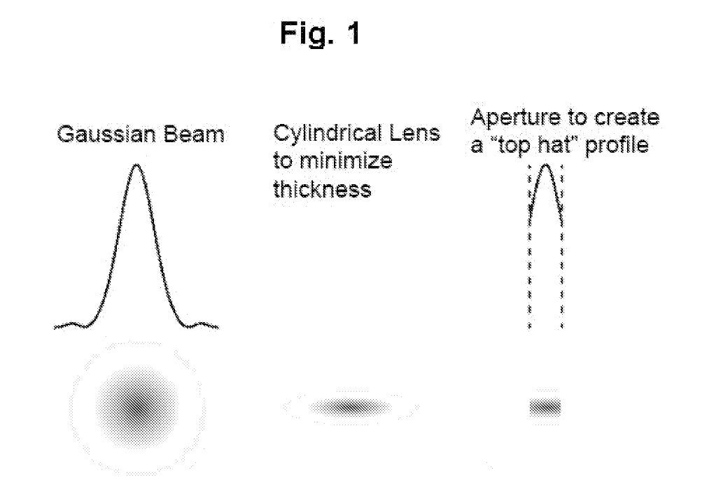

As seen in FIG. 1., the top-hat profile created via the present invention ensures consistent measurements may be taken. Through the use of the Powell lens, the present invention is able to achieve this idea top-hat profile while incurring minimal loss of beam energy.

It is understood that while the approach of the present invention is a more expensive approach, it is also more efficient and more accurate. The Powell lens employed by the present invention is a specially crafted lens that is only works for beam sizes it was designed for. This does not provide for much flexibility, and therefore, few changes can be easily made to the design.

The most common airborne particle counters are employed and created based on having coverage across an inlet nozzle of the particle counter, such that all the particles passing through the inlet nozzle are counted. Conventionally, using a cylindrical lens to focus the light to a flat ribbon (still maintaining a Gaussian profile) and clipping the edges to prevent illuminating particles that are not passing through the nozzle (incorrectly counted) is industry standard, and is considered sufficient. In general, it requires more engineering and cost to make the beam profile more uniform. The benefit of doing this additional work is a better signal and resolution of particle sizing while passing through the inlet nozzle. In response to this issue, the present invention employs the Powell lens in place of or in addition to the conventional cylindrical lens of particle counters, improving the accuracy, efficacy, and performance of the instrument through the creation of an efficient top-hat profile using a Powell lens.

The present invention preferably employs a single beam, a strip laser, and may include a strip of laser elements, such as an array of lasers used to create the top-hat profile.

Having illustrated the present invention, it should be understood that various adjustments and versions might be implemented without venturing away from the essence of the present invention. Further, it should be understood that the present invention is not solely limited to the invention as described in the embodiments above, but further comprises any and all embodiments within the scope of this application.

I claim:

1. A system for improving the beam profile of a particle counter comprising:
orienting at least one laser diode toward a Powell lens focused toward the particle counter;
the at least one laser diode emitting a beam of light through the Powell lens;
the Powell lens re-focusing the beam of light, focusing all energy coming from the at least one laser diode towards the particle counter to create a top-hat profile; and
the top-hat profile yields a consistent sample with uniform particle sizes.
